(19) United States
(12) Patent Application Publication
(10) Pub. No.: US 2012/0300060 A1
(43) Pub. Date: Nov. 29, 2012

(54) VISION SYSTEM FOR IMAGING AND MEASURING RAIL DEFLECTION

(75) Inventor: Shane M. Farritor, Lincoln, NE (US)

(73) Assignee: BOARD OF REGENTS OF THE UNIVERSITY OF NEBRASKA, Lincoln, NE (US)

(21) Appl. No.: 13/368,402

(22) Filed: Feb. 8, 2012

Related U.S. Application Data
(60) Provisional application No. 61/489,426, filed on May 24, 2011.

(51) Int. Cl. H04N 7/18

(52) U.S. Cl. 348/125; 348/E07.084

(57) ABSTRACT

Devices, systems, and methods for imaging and measuring deflections in structures such as railroad rail are disclosed. An example vision system comprises a high-speed, visible-light imaging camera and an evaluation unit configured for analyzing images from the camera to detect geometric variations in the structure. In analyzing structures such as railroad track rail, the imaging camera can be coupled to a moving rail vehicle and configured for generating images of the rail as the vehicle moves along the track.

### CROSS-REFERENCE TO RELATED APPLICATION

This application claims priority to U.S. Provisional Application No. 61/489,426 entitled “Imaging System For Measuring Vertical Rail Deflection,” filed May 24, 2011, which is incorporated herein by reference in its entirety for all purposes.

### FEDERALLY SPONSORED RESEARCH OR DEVELOPMENT

This invention was made with government support under FRA grant numbers DTFR53-04-G-00011 and DETF53-02-G-0015. The government has certain rights in the invention.

### TECHNICAL FIELD

The present disclosure relates generally to analyzing deflections in structures. More specifically, the present disclosure pertains to devices, systems, and methods for imaging and measuring deflections in structures such as railroad rail.

### BACKGROUND

The economic constraints of both passenger and freight railroad traffic are moving the railroad industry to higher-speed vehicles and higher axle loads. The heavy axle loads and high speeds of modern freight trains produce high track stresses leading to quicker deterioration of track condition. As a result, the demand for better track maintenance has also increased. Fast and reliable methods are thus needed to identify and prioritize track in need of maintenance in order to minimize delays, avoid derailments, and reduce maintenance costs.

The condition and performance of railroad track depends on a number of different parameters. Some of the factors that can influence track quality are track modulus, internal rail defects, profile, cross-level, gage, and gage restraint. Monitoring one or more of these parameters can improve safe train operation by identifying track locations that produce poor vehicle performance or derailment potential. Track monitoring also provides information for optimizing track maintenance activities by focusing activities where maintenance is critical and by selecting more effective maintenance and repair methods.

Track modulus is an important factor that affects track performance and maintenance requirements. Track modulus is defined generally as the coefficient of proportionality between the rail deflection and the vertical contact pressure between the rail base and track foundation. In some cases, track modulus can be expressed as the supporting force per unit length of rail per unit rail deflection. Track modulus is a single parameter that represents the effects of all of the track components under the rail. These components include the subgrade, ballast, subballast, ties, and tie fasteners. Both the vertical deflection characteristics of the rail as well as the track components supporting the rail can affect track modulus. For example, factors such as the subgrade resilient modulus, subgrade thickness, ballast layer thickness, and fastener stiffness can affect track modulus.

Both low track modulus and large variations in track modulus are undesirable. Low track modulus can cause differential settlement that subsequently increases maintenance needs. Large variations in track modulus, such as those often found near bridges and crossings, can also increase dynamic loading. Increased dynamic loading reduces the life of the track components, resulting in shorter maintenance cycles. A reduction in variations in track modulus at grade (i.e. road) crossings can lead to better track performance and less track maintenance. It has also been suggested that track with a high and consistent modulus will allow for higher train speeds and therefore increase both performance and revenue. Ride quality, as indicated by vertical acceleration, is also strongly dependent on track modulus.

In addition to track modulus, variations in rail geometry resulting from track defects can also affect track performance. The relationship between modulus and geometry is complex. In some cases, areas of geometry variations often correlate with areas of modulus variations and vice versa.

### SUMMARY

The present disclosure relates generally to imaging and measuring deflections in structures such as railroad rail. An example vision system for imaging geometric variations along a railroad track comprises at least one visible-light imaging camera adapted for coupling to a moving rail vehicle located on the rail, the imaging camera having a field of view along a line of sight substantially parallel to a longitudinal axis of the rail and configured for generating images of the continuous shape of the rail during vehicle movement along the rail; and an evaluation unit including an image processor configured for analyzing the images from the imaging camera and detecting one or more geometric variations along the length of the rail.

An example method for analyzing the geometric shape of a railroad track rail comprises acquiring a plurality of images from at least one visible-light imaging camera coupled to a moving rail vehicle, the imaging camera having a field of view along a line of sight substantially parallel to a longitudinal axis of the rail; detecting a location of the rail within each acquired image; identifying and measuring a change in the position or shape of the rail away from an expected position or shape of the rail within each image; and determining vertical track deflection data at a plurality of different locations along the rail.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a schematic view showing the vertical deflection of a railroad track rail when subjected to the weight of a railcar truck moving along a railroad track;

FIG. 2 is a block diagram of an illustrative vision system for imaging and measuring deflections in a structure;

FIG. 3 is a schematic view showing an illustrative implementation of the system of FIG. 2 for imaging and measuring vertical deflections along a railroad rail;

FIG. 4 is a schematic view showing another illustrative implantation of the system of FIG. 2 for imaging and measuring vertical deflections along a railroad rail;

FIG. 5 is a flow diagram showing an example method for imaging and measuring the geometric shape of a rail;

FIGS. 6A-6B are several views showing sample images taken from an imaging camera;

FIG. 7 is a schematic view of an illustrative system for imaging and measuring vertical deflections in a structure using structured measurement light;

FIG. 8 is an example image taken from an imaging camera, in which structured measurement light is visible on the rail;

FIGS. 9A-9D are several views showing the identification of various features on a rail using the illustrative system of FIG. 7;

FIG. 10 is a schematic view of an illustrative vision system for stereoscopically imaging and measuring vertical rail deflections along a rail; and

FIGS. 11A-11B are several views showing sample images taken from two imaging cameras; and

FIG. 12 is a flow diagram showing an example method for trending vertical track modulus using an imaging system.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

The present disclosure describes devices, systems, and methods for imaging and measuring deflections in structures such as railroad rail. In some embodiments, for example, the devices, systems, and methods can be used to detect geometric defects in the rail that can affect the calculation of vertical track modulus and/or other characteristics of the rail. Although various embodiments are described in the context of imaging and measuring rail deflections in railroad rail, the devices, systems, and methods described herein can be used to image and measure deflections in other types of structures that are subjected to static and/or dynamic loading.

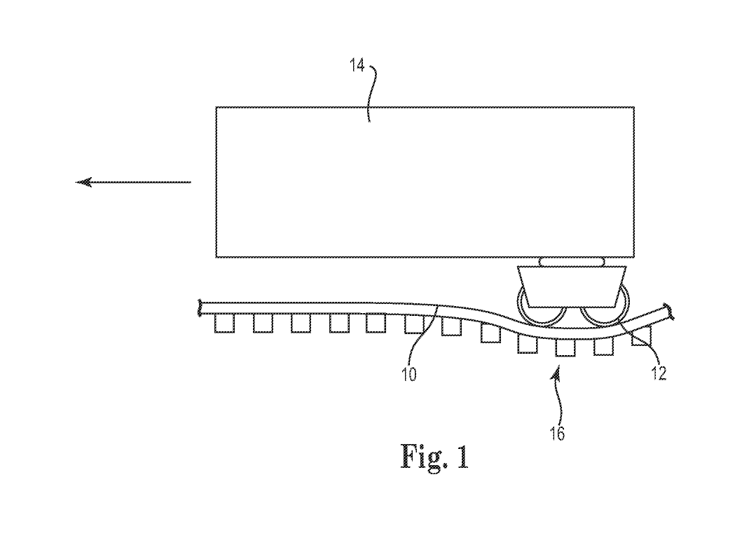

FIG. 1 is a schematic view showing the vertical deflection of a railroad rail 10 when subjected to the weight of a truck 12 from a railcar 14 moving along a railroad track 16. FIG. 1 may represent, for example, the vertical deflection of a railroad rail 10 along a damaged or compromised portion of the railroad track 16 that requires maintenance or replacement. As can be seen in FIG. 1, which is exaggerated for purposes of illustration, variations in track modulus and/or geometry can cause the rail 10 to deflect vertically when subjected to the load of the railcar 14. Such deflections can result in increased loading, which can reduce the life of the track 16 as well as the subgrade, ballast, subballast ties, tie fasteners, and other track components. In some cases, this increase in loading can result in an increase in maintenance necessary to keep the track 16 in service.

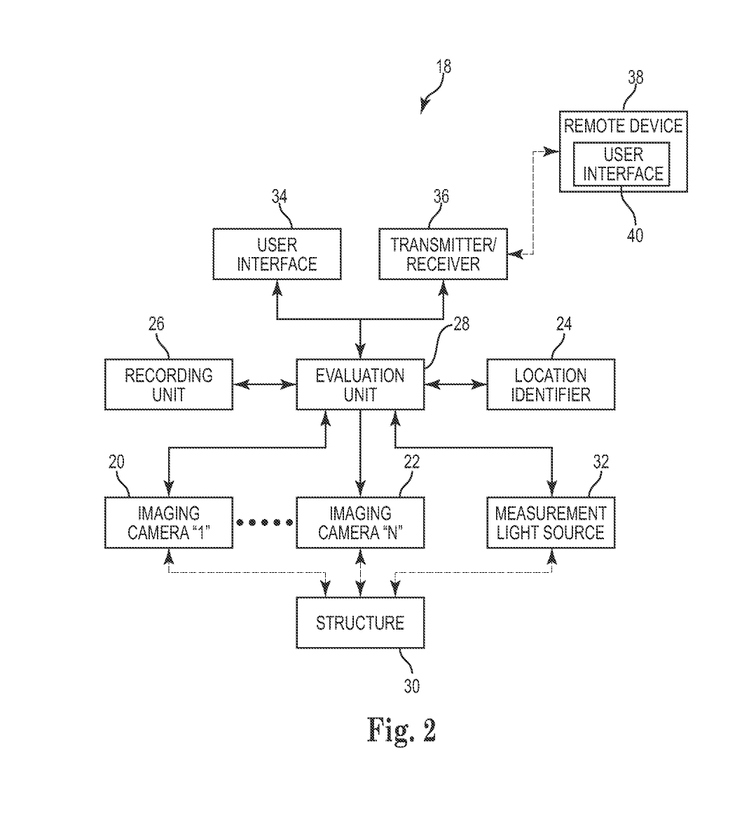

FIG. 2 is a block diagram of an illustrative vision system 18 for imaging and measuring deflections in a structure. As shown in FIG. 2, the system 18 includes one or more imaging cameras 20, 22, a location identifier 24, a recording unit 26, and an evaluation unit 28, which can be used to image and measure geometric deflections of a structure 30 subjected to static and/or dynamic loading. In certain embodiments, for example, the system 18 can be used for imaging and measuring vertical track modulus at multiple locations along a railroad rail 30 when subjected to vertical loads generated by a railcar or track loading vehicle. The system 18 can also be used for analyzing other types of structures such as bridges and elevated roadways. In some embodiments, and as discussed further herein, the system 18 can be used in conjunction with a trending algorithm for determining and monitoring changes in the condition of the structure 30 over a period of time.

The imaging cameras 20, 22 are configured to generate high-resolution images of the structure 30 that can be used to detect and analyze various geometric deflections in the structure 30. In some embodiments, the imaging cameras 20, 22 are coupled to a moving vehicle such as a railcar or rail test vehicle, and are configured to generate a series of images of the structure 30 as the vehicle moves along the structure 30. In some embodiments, only a single imaging camera 20 is used for imaging the structure 30. In other embodiments, multiple imaging cameras 20, 22 are used for stereoscopically imaging a single location on the structure 30 or for simultaneously measuring multiple locations on the structure 30. In one embodiment, for example, a first pair of imaging cameras 20, 22 are mounted to a railcar for stereoscopically imaging vertical track deflections along a first rail, and a second pair of imaging cameras 20, 22 are mounted to the railcar for stereoscopically imaging vertical track deflections along a second rail. The system 18 can be configured to gather data for one rail or for multiple rails. In addition, one or more additional imaging cameras can also be utilized for analyzing other structural features such as a third rail or other track components such as the cross ties, ballast, subballast, and/or rail fasteners.

The location identifier 24 acquires location data that can be associated with a time stamp of the images acquired by the imaging cameras 20, 22. In some embodiments, the location identifier 24 comprises a Global Positioning System (GPS) device for acquiring global location data that can be used to track the location of data measurements acquired over time with the corresponding locations on the structure 30. In the analysis of railroad rail, for example, the global location data from the location identifier 24 can be used to associate and trend deflection measurements obtained from the images along specific locations of the rail 10. In some embodiments, the system 18 is configured to trend this data to generate vertical track deflection and/or track modulus estimates along all or portions of the rail 10 over a period of time. Other information associated with the condition of the track can also be associated with the global location data to analyze other track characteristics. In some embodiments, for example, the images obtained from the imaging cameras 20, 22 are used to detect the presence of flaws or deflects in the rail and/or other track components.

The evaluation unit 28 includes an image processor configured to analyze the images generated by the imaging cameras 20, 22, and from these images, generate data associated with the deflection characteristics of the structure 30. In some embodiments, such data includes vertical rail deflection data associated with a rail when subjected to static and/or dynamic loading conditions. In certain embodiments, such data can be used in conjunction with geographic location data from the location identifier 24 to determine the vertical track modulus along all or portions of the rail.

The data evaluated by the evaluation unit 28 along with time stamp and geographic location data can be stored within the recording unit 26. The raw video images acquired by the imaging cameras 20, 22 can also be stored within the recording unit 26 for later analysis. In some embodiments, the raw video images are recorded and post processed by a processor coupled to a memory unit. The processor may comprise, for example, one or more microprocessors within the evaluation unit 28 configured for performing imaging processing.

In some embodiments, the system 18 further includes a measurement light source 32 configured to project a measurement light beam or multiple light beams on the structure 30 for illuminating various features on the structure 30 that can be used in analyzing the images. In certain embodiments, for example, the measurement light source 32 comprises a laser light source configured to project light onto the structure 30 to aid in analyzing the images acquired via one or more imaging cameras 20, 22. In the analysis of railroad track, and in some embodiments, the measurement light source 32 comprises a line laser source configured to project a reference line along the length of the rail that can be used to measure and analyze vertical deflections in the rail as well as well as the presence of any track turns or changes in track elevation that can affect the vertical deflection measurements. In another embodiment, the measurement light source 32 is configured to project multiple laser light beams each at different locations along the rail.

A user interface 34 permits users to view and analyze data acquired by the evaluation unit 28, to program the evaluation unit 28, and to perform other system functions. In some embodiments, the user interface 34 comprises a graphical user interface (GUI) that can be used to view graphs, tables, and/or other data associated with a structure or multiple structures, either in real-time and/or based on data stored within the recording unit 26. In some embodiments, the user interface 34 is configured to notify the user that a particular location of track may require maintenance or replacement. The images associated with each identified location can also be displayed on the user interface 34 to permit the user to visually inspect the images used to generate the notification. In some embodiments, a data transceiver 36 is configured to wirelessly relay data, settings, and other information back and forth between the evaluation unit 28 and a remote device 38 equipped with a remote user interface 40. As with user interface 34, the remote user interface 40 can also be used to view and analyze raw and processed data acquired by the evaluation unit 28, to remotely program the evaluation unit 28, and for performing other system functions.

One or more components of the system 18 can be implemented in hardware, software, and/or firmware. It should be understood that this and other arrangements described herein are set forth only as examples. Other arrangements and elements can be used in addition or, or in lieu of, those shown, and some elements may be omitted altogether. Furthermore, many of the elements described herein are functional entities that may be implemented as discrete or distributed components or in conjunction with other components, and in any suitable combination and location. In some embodiments, various elements and functions described herein can be implemented as computer readable instructions on a programmable computer or processor comprising a data storage system with volatile and/or non-volatile memory.

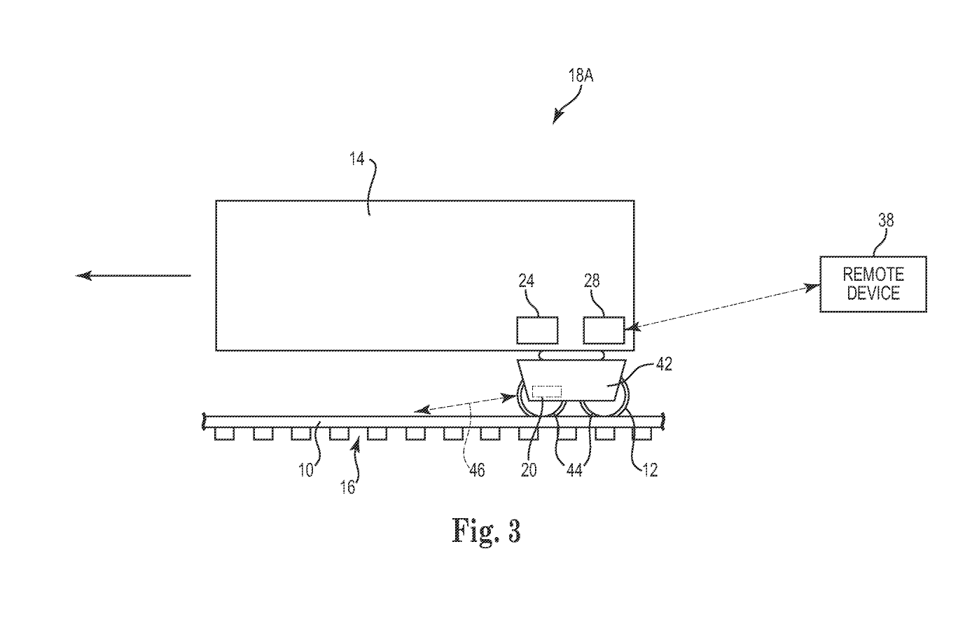

FIG. 3 is a schematic view showing an illustrative implementation of the system 18 of FIG. 2 for imaging and measuring vertical rail deflections along a railroad rail 10. In the embodiment shown in FIG. 3, the system 18A includes a single imaging camera 20 mounted rigidly to, or within, the sideframe 42 of a railcar truck 12. The imaging camera 20 can comprise, for example, a high speed visible-light camera that samples images at a significant frame rate (e.g., ≧120 frames per second) and at a high resolution (e.g., ≧1 megapixels per inch). Other types of imaging devices can also be used.

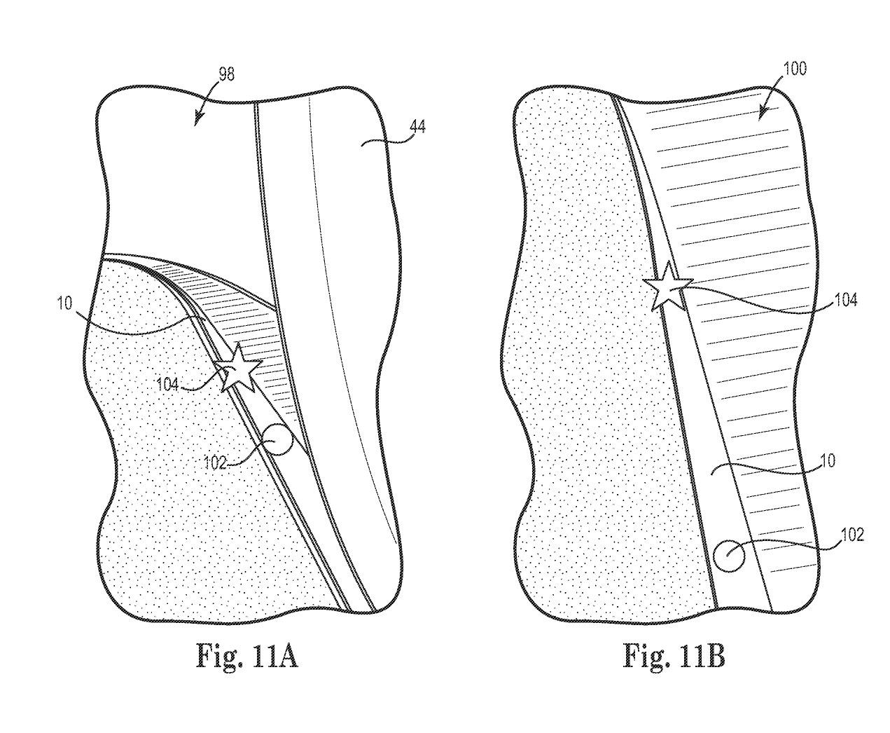

As shown in FIG. 3, the imaging camera 20 is secured to the sideframe 42 of the truck 12 such that the camera 20 remains in a substantially fixed position relative to the wheels 44 that contact the rail 10. The sideframe 42 can comprise, for example, a rigid structural member that connects the axles of the truck 12 together. In some embodiments, the imaging camera 20 is secured to the sideframe 42 such that the field of view of the camera 20 is directed along a line of sight 46 that is substantially parallel to a longitudinal axis of the rail 10 for generating images along the length of the rail 10 as the railcar 14 moves along the track 16. The imaging camera 20 can be aimed in a number of different directions to view various portions of the rail 10. For example, the imaging camera can be directed towards the center of the railcar 14, as shown, for example, in FIG. 11, or can be directed away from the center of the railcar 14. Other viewing directions are also possible, including towards the leading end of the railcar 14 or the trailing end of the railcar 14.

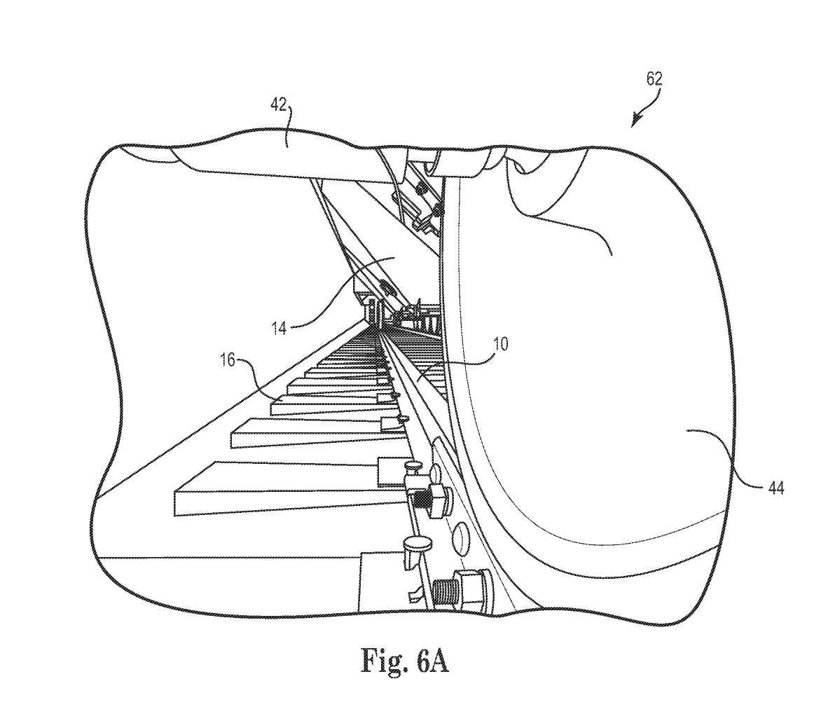

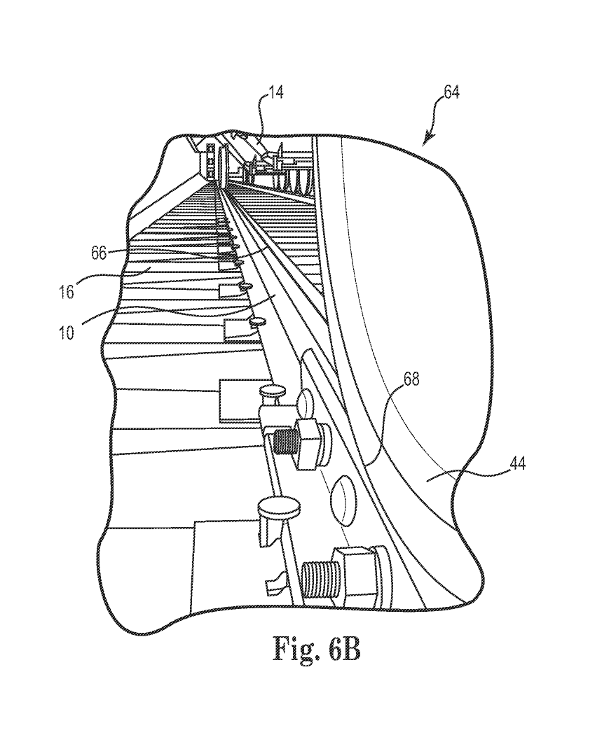

The imaging camera 20 can be mounted to the sideframe 42 of a trailing truck 12, as shown, or the sideframe of a leading truck. The imaging camera 20 could also be mounted to another structure that produces a fixed reference relative to a vertical, to the wheel/rail contact point(s), and/or to another reference point. The system 18A can also be used to identify the position of the rail 10 at one or several locations relative to the sideframe 42 of the truck 12. In some embodiments, a second high-speed visible-light imaging camera can be used for imaging the other rail 10 and/or for imaging other features along the track 16. Several example images that can be taken with the imaging camera 20 of FIG. 3 are further described herein with respect to FIGS. 6A-6B.

During operation, the system 18A is configured to image and analyze the continuous shape of the rail 10 as the railcar 14 moves along the track 16. A zoom lens may be provided to adjust the field of view and resolution of the imaging camera 20. In some embodiments, the system 18A can be used to image changes in the geometric shape of the rail 10 and/or other track components, which can then be combined with other sensed track parameters for determining vertical rail deflection, track modulus, stiffness, and/or other parameters in a manner similar to that described in U.S. Pat. Nos. 7,403,296 and 7,920,984 and U.S. Patent Publication Nos. 2009/0070064, 2007/0214892, and 2009/0056454, all of which are incorporated herein by reference in their entirety for all purposes. In one embodiment, for example, the imaging system 18A can be used to correct or compensate for any geometric variations in the rail 10, and can be combined with other rail parameters such as vertical track deflection to determine the presence of any defects in the rail 10 in real time. In comparison to other systems, the system 18A is simple to install, does not require significant modification of the railcar 14 or significant additional equipment, and has no moving parts.

In some embodiments, the system 18A employs machine vision techniques to identify the location of the rail 10 in each image and then process the measurements to find the geometric shape of the rail 10. In some embodiments, the evaluation unit 28 includes an image processor that receives the camera images, and from these images, determines the location, shape, size, curvature, and/or other parameters associated with the rail 10 and/or other track components. The evaluation unit 28 can comprise, for example, a computer (e.g., a laptop or desktop computer) with image processing, data computation, and data storage capabilities located within the railcar 14 and connected via a wired or wireless connection to each imaging camera 20. In some embodiments, the evaluation unit 28 is coupled to a remote device 38 that wirelessly receives the camera images from each imaging camera 20 and performs various image processing tasks in addition to, or in lieu of, the evaluation unit 28. In some embodiments, for example, the remote device 38 comprises a separate image processing station with image processing and data computation capabilities for analyzing camera images from one or more imaging cameras in real time. In some embodiments, data from each imaging camera can be logged and uploaded in real time from an on-board computer to a remote server through an internet or intranet or satellite or cellular connection. Other components such as a Global Positioning System (GPS) unit or odometer can be used to track the location of the railcar 14 along the track 16.

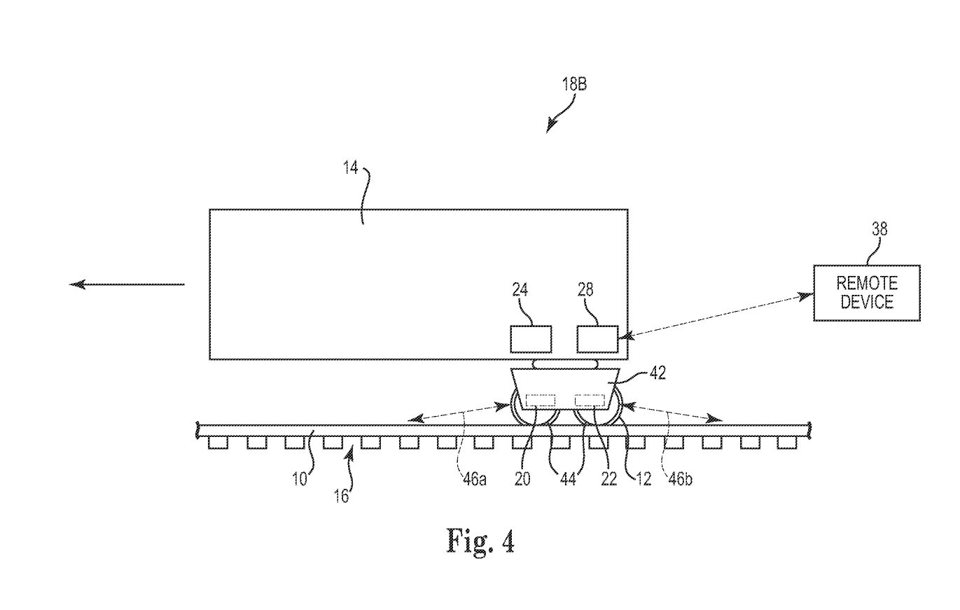

FIG. 4 is a schematic view showing another illustrative implementation of the imaging system 18 of FIG. 2 for imaging and measuring vertical rail deflections along a rail 10. In the system 18B of FIG. 4, two imaging cameras 20, 22 are coupled to a sideframe 42 of the railcar truck 12 with a first imaging camera 20 aimed along a line of sight 46a in a forward direction to view the portion of the track 16 the railcar 14 will soon pass over, and a second imaging camera 22 aimed along a line of sight 46b towards the rear of the railcar 14 to view the portion of the track 16 the railcar 14 recently passed over. Each imaging camera 20, 22 comprises a high speed visible-light camera, and is configured to image and analyze the continuous shape of the rail 10 as the railcar 14 moves along the track 16. The use of multiple imaging cameras 20, 22 allows the identification of the entire deflection basin, and in some embodiments can be used to correct for changes in track geometry caused by hills, valleys, or other geographic features.

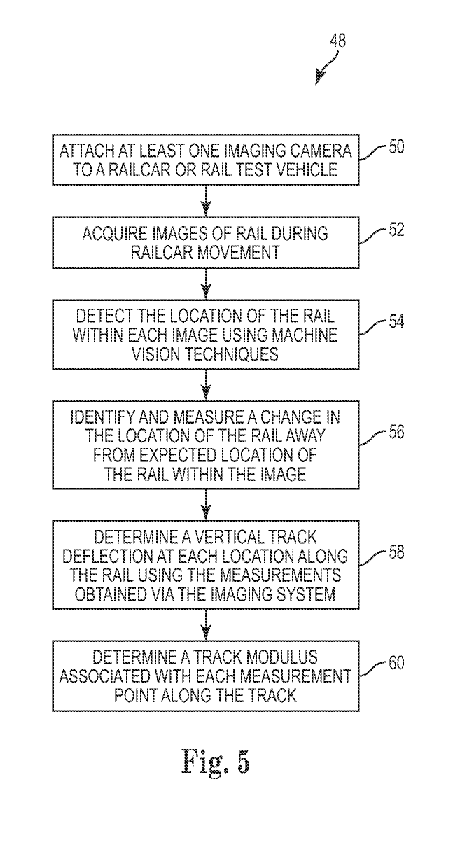

FIG. 5 is a flow diagram showing an example method 48 for imaging and measuring the geometric shape of a rail. The method 48 may begin generally at block 50, in which at least one imaging camera is attached to a sideframe of a railcar or track loading vehicle. In certain embodiments, for example, two imaging cameras can be coupled to a single railcar truck to acquire images for each rail of the track. In one embodiment, for example, a first imaging camera located on a first sideframe of the truck can be used to image a first (e.g., left) rail, and a second imaging camera located on another sideframe located on the opposite side of the truck can be used to image a second (e.g., right) rail. Multiple imaging cameras can be coupled to each sideframe to permit imaging both in a forward and rearward direction, or for stereoscopically imaging each rail.

Once connected to a railcar, each imaging camera can be tasked to continuously or intermittently acquire images of the rail as the railcar moves along the track (block 52). An example image of a rail that can be acquired is further shown and described herein with respect to FIG. 6A. From the acquired images, the evaluation unit employs machine vision techniques to detect the location of the rail within each acquired image (block 54).

Numerous different types of machine vision techniques can be employed to detect the location of the rail including, but not limited to, edge detection and/or feature recognition methods. If a single imaging camera is employed, for example, an edge detection method can be used to examine features of groups of pixels such as the intensity and/or color of each pixel as well as surrounding pixels. In one approach, for example, the intensity of each pixel within a group can be measured. From these measurements, and a maximum and minimum intensity of these pixels are then determined. If the difference between the maximum and minimum pixel intensity for the group is greater than a threshold value, this indicates a change in the image and the current pixel under evaluation is assigned a value of 1. If the difference between the maximum and minimum pixels is less than the threshold, then the current pixel is assigned a value of zero. This process of evaluating pixels is then repeated throughout all or a portion of the image, yielding the areas where the image has changes, or edges. In some embodiments, this technique can be used in identifying the edges of the rail, and thereby the slope of the rail in the image.

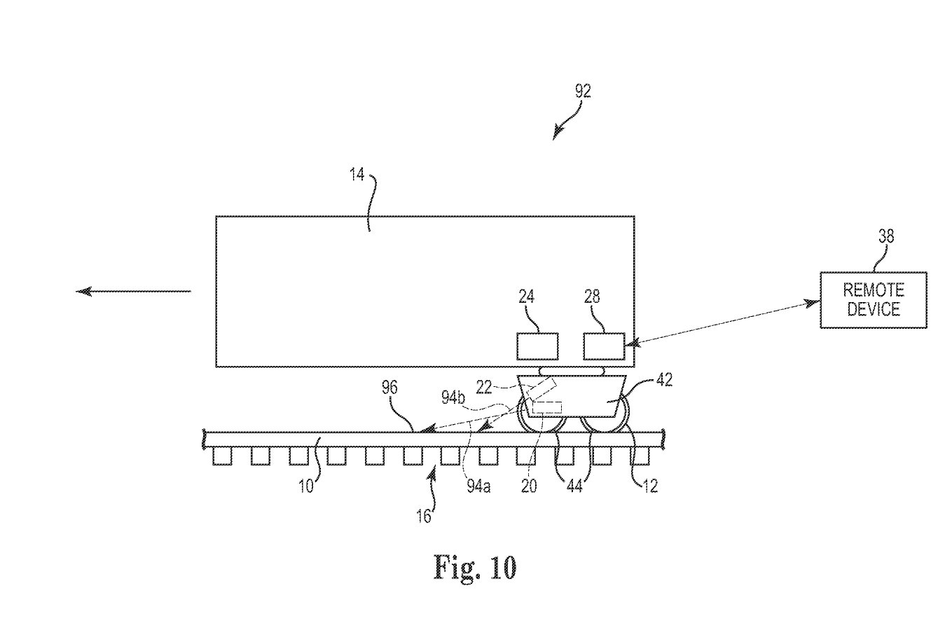

Another machine vision technique that can be used to detect the location of the rail includes using color or other image features to detect blobs or recognize features or classify the pixels in the image such as the rail or structured measurement light. If two imaging cameras are used, stereoscopic imaging techniques that use edge detection or feature recognition methods can also be employed. An example vision system and technique for stereoscopically imaging and measuring the location of a rail is further described herein with respect to FIGS. 10 and 11A-11B.

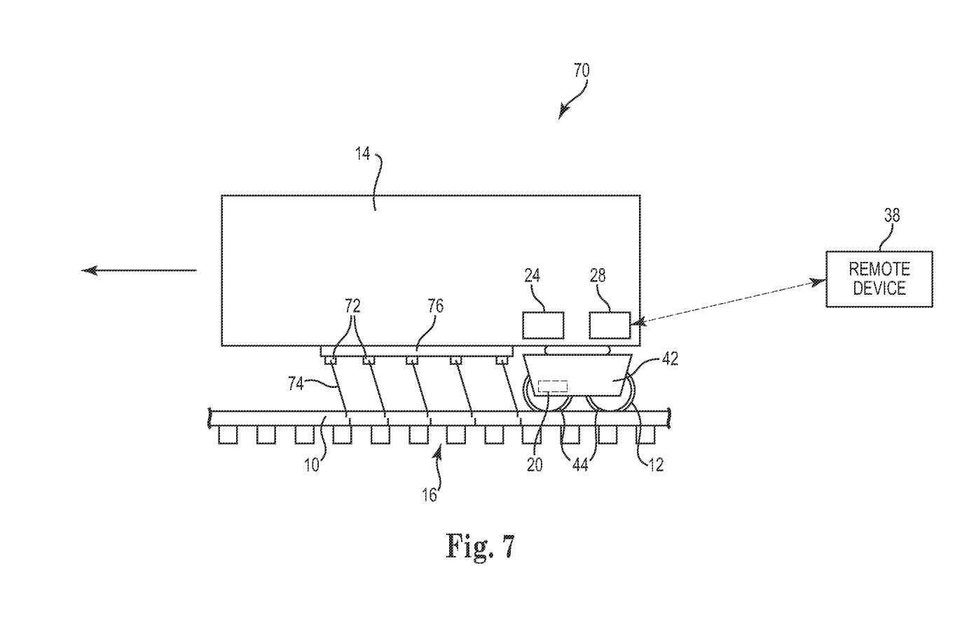

As further shown in FIG. 5, the evaluation unit can also be configured to identify and measure a change in the location of the rail away from an expected location of the rail within the image (block 56). In certain embodiments, and as discussed further herein, the evaluation unit is configured to superimpose a straight reference line over the location of the rail within the image, and from the reference line, measure a vertical deflection of the rail within the image. The evaluation unit may also compensate the measurements with any natural turns in the track or any transverse movement of the wheels relative to the centerline of the track. An example of structured measurement light that can be used as part of the process of identifying and measuring changes in the location of the rail away from an expected location of the rail within an image is discussed further herein with respect to FIGS. 7-9.

Additional techniques can be used to calibrate the camera images relative to true measurements in the real world. As examples, known objects can be placed in view along the deflected rail and the shape of the rail can be measured with other techniques such as GPS or a surveyor's system or rulers. In addition, the railcar could be moved onto a very stiff section of track, such as a slab track or track over concrete in a car shop, and the shape of the relatively straight rail could be used to establish the calibration.

The method 48 can further include determining a vertical track deflection at each location along the rail using the measurements obtained with the imaging system (block 58). In some embodiments, the measured vertical track deflection measurements can be used to further determine a track modulus associated with each measurement point along the track (block 60), which can be used to determine whether portions of the track may require maintenance. In some embodiments, these measurements can also be used to determine whether there may have been any tampering with the rail that may require immediate servicing. The imaging system could also be used to measure the quality of the track structure, and could be used to identify other problems such as broken ties or missing bolts in the joints, or to detect the presence of foreign material on the track such as natural debris or implements left to damage the track.

In some embodiments, the measurement of vertical track deflection can also be combined with other measurements of track geometry and/or track quality to produce new metrics of track quality. Examples of other measurements that can be made include gage, cant, mid-cord offsets, end-cord offsets, measurements of longitudinal rail stress, measurements of gage restraint, measurements of vehicle track interaction or other acceleration based measurements.

FIGS. 6A-6B are several views showing sample images taken from an imaging camera 20. The images may represent, for example, several images used as part of the method 48 of FIG. 5 for determining the geometric shape of a rail using the system 18A of FIG. 3.

FIG. 6A is an example image 42 taken from an imaging camera 20 mounted to the sideframe 42 shown in FIG. 2. As can be seen from the image 42, the imaging camera is mounted to the sideframe 42 such that the field of view of the camera is forward-facing and is directed towards the rail 10 along a line of sight substantially parallel to the rail 10.

FIG. 6B is an example image 64 showing another example image from the imaging camera 20 that can be used as part of an image processing algorithm or routine. As shown in FIG. 6B, a single, straight reference line 66 can be added to or superimposed onto the image 64 to illustrate how the rail 10 deflects under the weight of the railcar. If the rail 10 were infinitely stiff and perfectly straight, the rail 10 would appear on the image 64 as a straight line, and would be substantially collinear with the reference line 66. As can be seen in the image 64 of FIG. 6B, however, the weight of the railcar causes the rail 10 to deflect, causing the rail 10 to deviate from the straight path of the superimposed reference line 66.

The wheel/rail contact point 48 shown in the bottom right of the camera image 44 will not move much in the image 44. This is partly due to the imaging camera being secured to the sideframe 42 of the truck, which is substantially rigid and fixed relative to the wheels 44, and does not deflect significantly as the railcar 14 moves along the track. In comparison, the portion of the rail 10 further away from the imaging camera may move significantly as a result of turns in the track 16 or transverse movement of the wheel set relative to the centerline of the track 16. During image processing, these “rigid body” motions of the rail 10 are removed from the estimated shape of the rail 10 using mathematical techniques. The curvature of the rail 10 is thus extracted from the images.

In some embodiments, machine vision techniques can be used to find the shape of the rail 10 and estimate the deflection of the rail 10 by comparing the location, or change in location, of the reference line 66 relative the rail 10 within the field of view. In some embodiments, multiple cameras can be used simultaneously to identify the shape of the rail 10. For example, multiple imaging cameras can be used for stereo vision, or each imaging camera might have different spectral (or other sensitivity) responses to be used to identify the shape of the rail 10.

FIG. 7 is a schematic view of an illustrative vision system 70 for imaging and measuring vertical rail deflection of a rail 10 using structured measurement light. Similar to the embodiment of FIG. 3, the system 70 includes one or more imaging cameras 20 mounted rigidly to, or mounted within, the sideframe 42 of a railcar truck 12. The imaging cameras 20 can comprise, for example, high speed visible-light cameras configured to image and analyze the continuous shape of the rail 10 as the railcar 14 moves along the track 16. In the embodiment of FIG. 7, the system 70 further includes a series of line lasers 72 that each transmit a corresponding reference line 74 onto the rail 10 at a location within the field of view of the imaging camera 20. In certain embodiments, the lasers 72 are coupled to the railcar 14 via a body-mounted beam 76, and are configured to direct laser lines 74 across a transverse axis of the rail 10. The lasers 72 and imaging cameras 20 are mounted such that the distance between each camera 20 and the lasers 72 is substantially constant. During image processing by the evaluation unit 28, the laser lines 74 act as structured light to aid in detecting geometric variations in the rail 10. To permit detection of the laser lines 74, the imaging camera 20 is configured for imaging in a frequency range that overlaps with a frequency range of the laser lines 74 provided by the lasers 72. Although line lasers 74 are shown in the embodiment of FIG. 7, other forms of structured light could be used such as point lasers, multi-spectral light, and others.

The imaging camera(s) 20 and the line lasers 74 can be used in combination with each other, or can be configured to function independent of each other. For example, raw images acquired from the imaging cameras (e.g., image 64 in FIG. 6A) might be used in the daytime whereas the structured light obtained via the line lasers 72 might be used at night or in low-light conditions. In other embodiments, the structured light can be used to better identify the location of the rail 10 relative to the sideframe 42 at several discrete locations along the rail 10.

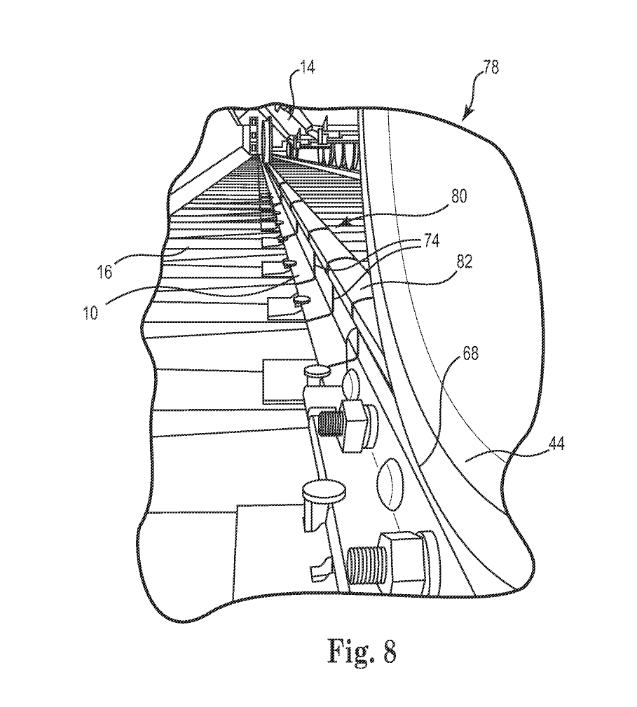

FIG. 8 is an example image 78 taken from an imaging camera, in which structured light 80 (e.g., from the laser beams 74 shown in FIG. 7) are visible on the rail 10. From the image 78 in FIG. 8, the evaluation unit may detect and zoom in on the sections where the laser beams 74 reflect on the top 82 and/or other portions of the rail 10. The presence of the laser beams 74 allows the evaluation unit to more easily identify the shape of the rail 10. The evaluation unit can detect the laser beams 74, for example, by scanning through all of the pixels on each horizontal line of the image 78, and locating the peaks of the pixel intensities or colors that represent the locations of the laser lines 74.

The wheel/rail contact point 68 shown in the bottom right of the camera image 78 will not move much in the image 78 due to the imaging camera being secured to the sideframe of the truck. However, the location of the rail 10 further away from the imaging camera may move significantly as a result of turns in the track or transverse movement of the wheel set relative to the centerline of the track. These “rigid body” motions of the rail can be removed from the shape of the rail 10 using mathematical techniques and the curvature of the rail 10 can be extracted.

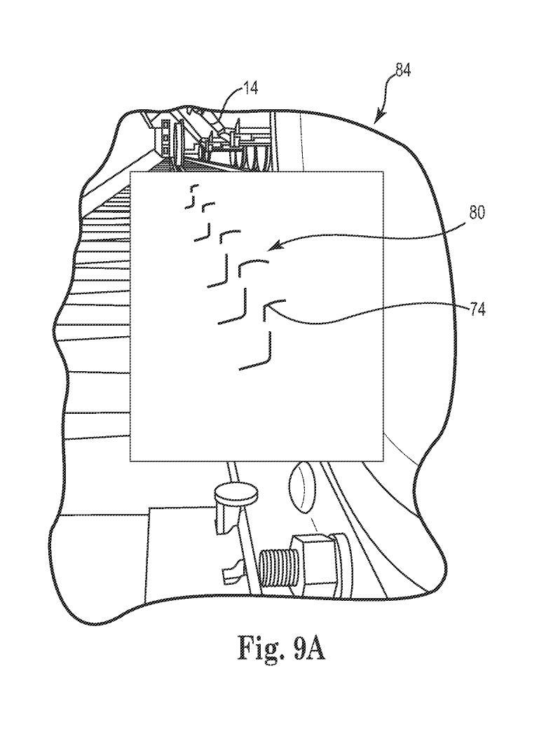

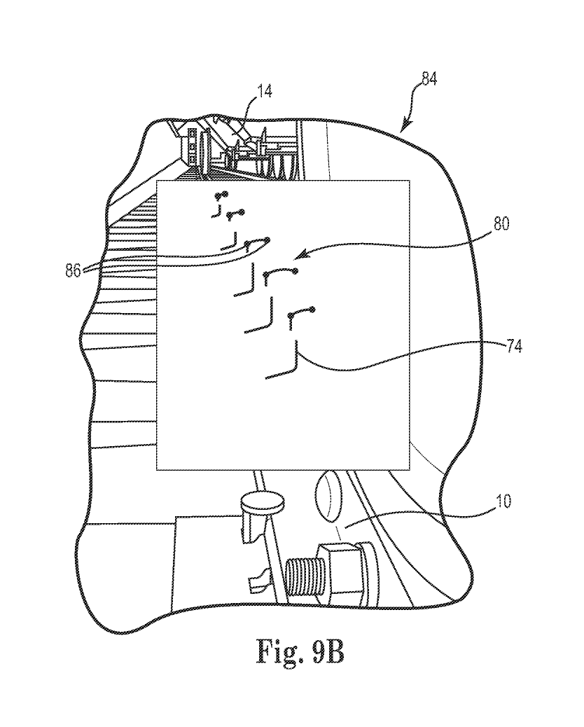

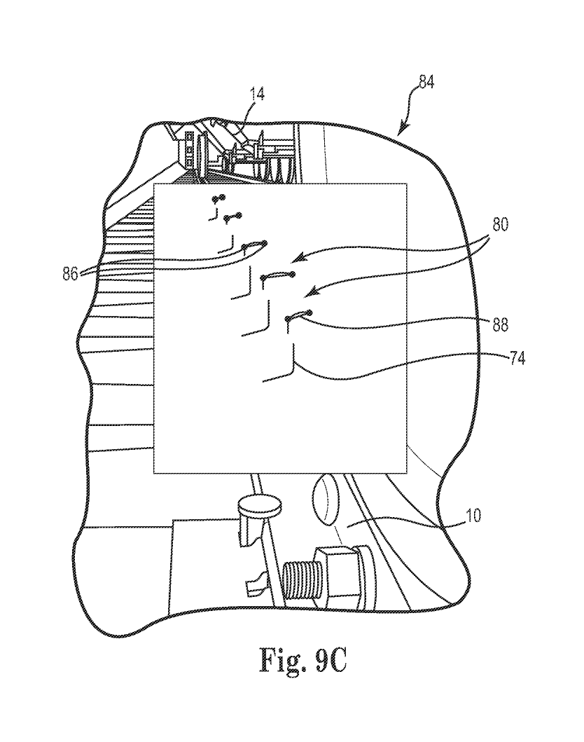

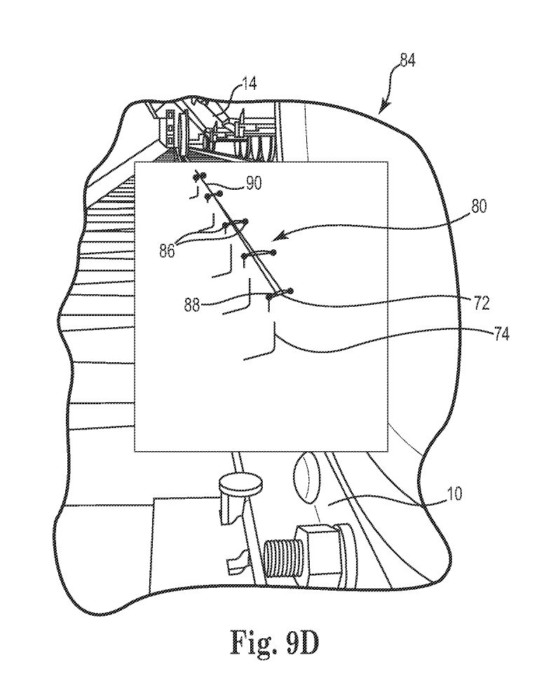

The image 78 can be processed to isolate the structured light (e.g., laser lines 74) projected onto the surface of the rail 10. Several example views of a camera image 84 showing the isolation of the structure light 80 on the rail 10 are shown in FIGS. 9A-9C.

Machine vision techniques can be used to extract features from the image 84 based on the color, intensity, and/or other factors of the structured light 80. In one example embodiment, optical filters on the imaging camera are matched to the wavelength of the light beams 74, allowing the evaluation unit to increase the intensity of the structured light 80 relative to the rest of the image. In some embodiments, the imaging camera uses the structured light 80 to better identify the location of the rail 10 relative to the sideframe. For example, five structure light lines 74 are shown in the image 84 of FIG. 9A, however, a greater or lesser number may be used in other embodiments.

Once the laser lines 74 are identified in the image, the corners 86 of the top of the rail surface (as represented by the dots) can be identified as discontinuities in the rail head. An example of this is shown FIG. 9B, in which dots 86 have been superimposed on the corners or edges of the top of the rail 10 as identified by the laser lines 74. Other features of the rail (e.g., the corner of the base, web, etc.) can also be identified in the image 84 to estimate the overall rail shape.

From the location of the corners identified on the rail 10, the centerline of the rail 10 can be identified, for example, by connecting all the midpoints of the dots 86 together. This can be seen in the image 84 of FIG. 9C, in which a transverse line 88 is drawn between the dots 86 for each corresponding laser line 72 superimposed onto the rail 10.

Finally, the vertical deflection of the rail and/or other parameters related to the rail shape such as cant or gage restraint can be estimated using mathematical techniques. For example, FIG. 9D shows how the shape of the centerline of the top of the rail 10 can be compared to a straight line 90 connecting the midpoints 86 of each transverse line 88 to estimate the vertical rail deflection and/or the shape of the deflection basin.

FIG. 10 is a schematic view of an illustrative vision system 92 for stereoscopically imaging and measuring vertical rail deflections along a rail. In the embodiment of FIG. 10, the system 92 includes two or more imaging cameras 20, 22 mounted rigidly to, or within, the sideframe 42 of a railcar truck 12 such that the cameras 20, 22 remain in a fixed position relative to the wheels 44 that contact the rail 10 The sideframe 42 can comprise, for example, a rigid structural member that connects the axles of the truck 12 together.

In some embodiments, and as shown, the system 92 includes a first imaging camera 20 directed along a first line of sight 94b on the rail 10 (e.g., the rail head), and a second imaging camera 22 spaced apart from the first imaging camera 20 and directed along a second line of sight 94b on the rail 10. The line of sights 94a, 94 can be either non-parallel, as shown, or can be parallel to each other or with respect to another reference line such as the centerline of the railcar 14.

Each imaging camera 20, 22 comprises a high speed visible-light camera, and is configured to image and analyze the continuous shape of the rail 10 as the railcar 14 moves along the track 16. The imaging cameras 20, 22 can comprise, for example, high speed visible light cameras that sample images at a frame rate of 120 frames per second. Although for purposes of illustration separate imaging cameras 20, 22 are shown in FIG. 10, in other embodiments a single imaging device comprising two or more imaging elements can be used for stereoscopically imaging the rail 10. Other types of imaging devices can also be used.

The system 92 is simple to install, does not require significant modification of the railcar 14, and has no moving parts. The system 92 can also be used to identify the position of the rail 10 at one or more locations relative to the sideframe 42 of the truck 12. In some embodiments, the images acquired by each imaging camera 20, 22 can be analyzed by the evaluation unit 28 to determine the shape of the rail 10 as the railcar 14 moves along the track 16. In certain embodiments, for example, the evaluation unit 28 is configured to evaluate the images received from each imaging camera 20, 22 to detect the location of the rail 10 within each image, and based on a comparison of features within each image, identify any changes in the geometric shape of the rail 10 and/or other track components. In some embodiments, the system 92 can be used to image changes in the geometric shape of the rail 10 and/or other track components, which can then be combined with other sensed track parameters for measuring vertical rail deflection, track modulus, stiffness, and/or other parameters. In one embodiment, for example, the system 92 can be used to correct or compensate for any geometric variations in the rail 10, and can be combined with other rail parameters such as vertical track deflection to determine the presence of any defects in the rail in real time.

FIGS. 11A and 11B are views showing sample images 98, 100 of a rail 10 taken from imaging camera 20 and 22 of FIG. 10, respectively. In a first image 98 shown in FIG. 11A, the first imaging camera 20 captures images that can be used for general stereo visualization to detect the position of the rail 10 relative to the sideframe. In a second image 100 shown in FIG. 11B, the second imaging camera 22 acquires images in a different perspective from the first imaging camera 20. In some embodiments, and as shown in FIG. 11B, the second imaging camera 22 acquires images along a line of sight that is more vertically (i.e., downward) oriented than the first imaging camera 20, and thus is capable of determining lateral movement of the rail 10. In some embodiments, structured measurement light such as a straight reference line or multiple laser beams can also be projected onto the rail 10 to aid in detecting geometric variations in the rail 10.

A stereo vision algorithm can be used to identify the position of the rail 10 relative to the vision imaging system. As can be seen in both FIGS. 11A and 11B, two sample locations 100, 102 along the rail 10 are shown, and can be designated on the images 98, 100 using an icon such as a circle and star, respectively. In some embodiments, the locations 100, 102 are identified using structured measurement light. For example, the position of these locations 100, 102 can be identified relative to the sideframe, and then the two positions can be connected in space to indicate the orientation of the rail 10 relative to the sideframe.

Stereo vision algorithms can be used to identify specific locations or features on each individual image 98, 100 including, but not limited to, blob detection, edge detection, feature detection, or other suitable technique. Correspondence algorithms can be used to locate individual features in each image 98, 100. A mathematical technique such as triangulation can then be used to identify the location of that feature relative to the vision imaging system. Known calibration techniques can be used to determine the camera geometry and optical properties.

The data acquired by any of the systems described herein can be combined with other track parameters for measuring vertical rail deflection, track modulus, stiffness, and/or other parameters. Global location data from the location identifier 24 can be used to associate and trend deflection measurements obtained from the images along specific locations of the rail 10. In some embodiments, the system 92 is configured to trend this data to generate vertical track deflection and/or track modulus estimates along all or portions of the rail over a period of time.

In some embodiments, the system can be used to measure track performance over a period of time in order to predict future track behavior. Measurements may be taken, for example, over a period of several months or years and stored in memory for later analysis. Based on these measurements, an analysis can be performed by the evaluation unit or another device (e.g., remote device) to measure a trend of the track performance. In some embodiments, for example, a measurement made at a first time and a measurement made at a second time may be used to predict one or more future track properties at a particular location or at multiple locations along the rail. For purposes of performing a trending analysis, relative comparisons can be made over short sections of track. For example, in some embodiments, a relative comparison can be made to evaluate one measurement relative to a previous measurement made at the same track location at an earlier time.

A cross-correlation function can be used to mathematically quantify location offsets in order to take an average over a distance of track. Cross-correlation is a technique for estimating the degree of correlation between two sets of measurements, and is described further in U.S. Pat. No. 7,920,984, which is incorporated herein by reference in its entirety for all purposes. A line or other curve may be fitted to the collected trend data to predict future track performance. Collected data may be from a first time and a second time, or may be from any number of times. In some embodiments, a trending analysis can be performed to predict at what time in the future the track performance may fall outside of acceptable parameters, thus requiring maintenance or replacement.

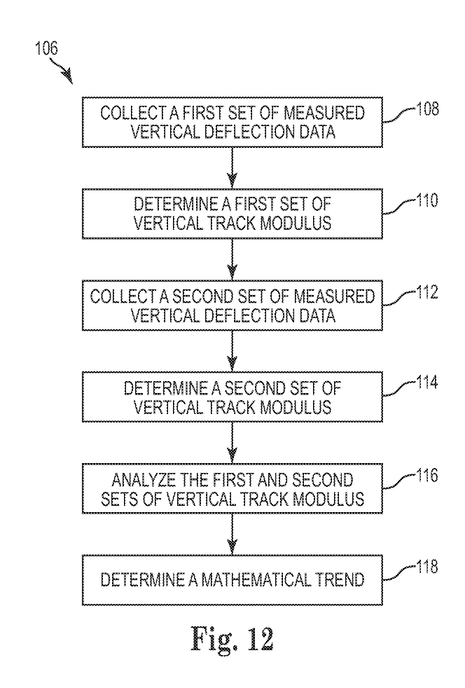

FIG. 12 is a flow diagram showing an example method 106 for trending vertical track modulus using any the vision systems described herein. The method 106 may represent, for example, an illustrative method for trending vertical track modulus using the stereoscopic imaging system 92 of FIG. 10. Other systems or combination of systems described herein can be also be used for trending vertical track modulus.

As shown in FIG. 12, the method may begin generally at block 108 in which a first set of measured vertical deflection data is collected along a portion of railroad track. In some embodiments, the vertical deflection data is collected by one or more imaging cameras and is analyzed by an evaluation unit configured to detect and measure various geometric deflections in the structure. In some embodiments, structured measurement light and/or the superposition of reference lines are used for detecting various features within the images such as the presence of any turns or elevation changes in the track. In certain embodiments, the vertical deflection data in is stored in the recording unit and/or is transmitted to another device such as a remote device.

As indicated generally at block 110, a first set of vertical track modulus data is determined. In some embodiments, the first set of vertical track modulus data is determined, based in part, on the first set of measured vertical deflection data. As previously described, a variety of different algorithms and methodologies may be employed to determine the first set of vertical track modulus. For example, a Winkler model such as that described in U.S. Pat. No. 7,920,984 can be used for determining vertical track modulus based on measured vertical deflection data. In some embodiments, the first set of measured vertical deflection data and the resulting first set of vertical track modulus are associated with a particular track location at a particular time. Therefore, the first set of vertical track modulus determined at a block 110 can be compared to vertical track modulus determined for previous or subsequent times. As a result, the first set of vertical track modulus, in combination with either previous or subsequent vertical track modulus, are useable to develop a trending algorithm.

As indicated generally at block 112, a second set of measured vertical deflection data is collected. In some embodiments, the second set of measured vertical deflection data is collected for a particular track location that corresponds with the same or similar track location associated with the first set of measured vertical deflection data collected at block 108. In some embodiments, the second set of measured vertical deflection data is collected at a time subsequent to the first set of measured vertical deflection data, but along a common track location. The second set of measured vertical deflection data can be used for determining a second set of vertical track modulus (block 114).

As indicated generally at block 116, the first and second sets of vertical track modulus are analyzed. In some embodiments, the analysis results in a mathematical algorithm that can be graphically charted to represent a trend associated with the track modulus of the particular track location associated with the first and second sets of vertical track modulus. Multiple sets of vertical track modulus can also be used to determine the mathematical algorithm. For example, three or more sets of vertical track modulus may be utilized to develop the mathematical algorithm, resulting in a higher order algorithm and a potentially closer fitting curve.

In some embodiments, the analysis of the first and second sets of vertical track modulus includes compensating for a location offset. For example, the precision of the location associated with each set of collected data may allow for a discrepancy between the recorded data for a particular location. This discrepancy is known as a location offset. In an exemplary embodiment, the location offset is identifiable from collected data at a point where an outlier in the data is consistently recorded. For example, an approach to a bridge may include a defining point in vertical deflection measurements where the underlying rail support dramatically changes, resulting in a defining point in the collected data. If, for example, the track is supported by a loose stone aggregate, but the bridge approach is supported by a compacted solid support, such as concrete, the measured vertical deflection data may abruptly change at this particular location. The location associated with the abrupt change will remain constant, but the location identified by a location identifier, such as the location identifier 24 of FIG. 2 may indicate a discrepancy between data sets. Therefore, the discrepancy between data sets may then be used to correct the location offset of the data sets based on an assumption that the abrupt change in measured vertical deflection occurred at a constant location. Other techniques could also be used for determining the location offset.

As indicated generally at block 118, a mathematical trend of the data is determined based on the analysis performed at block 116. In some embodiments, the mathematical algorithm created based on the first and second sets of vertical track modulus is utilized to fit a line or curve. The fitted line or curve represent a mathematical trend that can be utilized to forecast the vertical track modulus. In some embodiments, the mathematical trend is analyzed to determine an expected time for the forecasted vertical track modulus to meet or exceed a predefined threshold in the future. The predefined threshold can be defined at any level of vertical track modulus or vertical deflection that allows the trending algorithm to provide a beneficial result.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A vision system for imaging geometric variations along a length of a railroad track rail, the system comprising:
at least one visible-light imaging camera adapted for coupling to a moving rail vehicle located on the rail, the imaging camera having a field of view along a line of sight substantially parallel to a longitudinal axis of the rail and configured for generating images of the continuous shape of the rail during vehicle movement along the rail; and
an evaluation unit including an image processor configured for analyzing the images from the imaging camera and detecting one or more geometric variations of the rail along the length of the rail.

2. The system of claim 1, wherein the imaging camera is coupled to a sideframe of the rail vehicle and is substantially rigid with respect to a contact point of a wheel to the rail.

3. The system of claim 1, further comprising:
a location identifier configured for acquiring global location data corresponding to a global location of the rail vehicle; and
a recording unit configured for storing data from the evaluation unit and the location identifier.

4. The system of claim 1, further comprising a transceiver configured for communicating data between the evaluation unit and a remote device.

5. The system of claim 1, further comprising a measurement light source configured for projecting structured light onto a surface of the rail.

6. The system of claim 4, wherein the measurement light source comprises a plurality of lasers configured for projecting multiple light beams each at different locations along the length of the rail.

7. The imaging system of claim 6, wherein the lasers are coupled to the rail vehicle via a beam.

8. The system of claim 6, wherein each light beam is projected across a transverse axis of the rail perpendicular to the longitudinal axis.

9. The system of claim 5, wherein the measurement light source comprises a laser configured for projecting a laser line onto a head of the rail in a direction along the longitudinal axis of the rail.

10. The system of claim 1, wherein the evaluation unit is configured to measure vertical deflections along the rail.

11. The system of claim 10, wherein the evaluation unit is further configured for determining a vertical track modulus of the rail based at least in part on the measured vertical deflections.

12. The system of claim 10, further comprising a means for trending a plurality of vertical deflection measurements over a period of time and predicting a future track performance associated with the track based at least in part on the vertical deflection measurements.

13. The system of claim 1, wherein the at least one visible-light imaging camera comprises a single imaging camera coupled to a sideframe of the rail vehicle.

14. The system of claim 13, wherein the imaging camera comprises a forward-facing imaging camera configured for imaging a portion of the rail in front of the sideframe.

15. The system of claim 1, wherein the at least one visible-light imaging camera comprises a plurality of imaging cameras each coupled to a sideframe of the rail vehicle.

16. The system of claim 15, wherein the imaging cameras are configured to stereoscopically image the rail.

17. The system of claim 1, wherein the at least one visible-light imaging camera comprises a forward-facing imaging camera configured for imaging a first portion of the rail in front of the sideframe and a rear-facing imaging camera configured for imaging a second portion of the rail rearward of the sideframe.

18. A vision system for imaging geometric variations on a structure subjected to loading, the system comprising:
at least one visible-light imaging camera adapted to move relative to the structure, the imaging camera configured for generating a plurality of images of the structure over a period of time;
an evaluation unit including an image processor configured for analyzing the images from the imaging camera and measuring vertical deflections in the structure at a plurality of different locations on the structure; and
a means for trending the vertical deflection measurements over the period of time and predicting a future performance of the structure.

19. A method for analyzing the geometric shape of a railroad track rail, the method comprising:
acquiring a plurality of images from at least one visible-light imaging camera coupled to a moving rail vehicle, the imaging camera having a field of view along a line of sight substantially parallel to a longitudinal axis of the rail;
detecting a location of the rail within each acquired image;
identifying and measuring a change in the position or shape of the rail away from an expected position or shape of the rail within each image; and
determining vertical track deflection data at a plurality of different locations along the rail.

20. The method of claim 19, wherein identifying and measuring a change in the position or shape of the rail away from the expected position or shape comprises projecting structured measurement light onto a surface of the rail, and measuring a vertical deflection of the rail within the image using the measurement light.

21. The method of claim 19, wherein identifying and measuring a change in the position or shape of the rail away from an expected position or shape of the rail within each image comprises superimposing a straight reference line onto a top surface of the rail within the image and measuring a vertical deflection of the rail using the reference line.

22. The method of claim 19, wherein identifying and measuring a change in the position or shape of the rail away from an expected position or shape of the rail within each image comprises superimposing a plurality of light beams onto a transverse axis of the rail at multiple different locations along a length of the rail.

23. The method of claim 22, wherein identifying and measuring a change in the position or shape of the rail away from an expected position or shape of the rail within each image comprises estimating a shape of the rail within the image.

24. The method of claim 23, wherein determining the vertical track deflection data comprises removing one or more rigid body motions of the rail vehicle from the estimated shape of the rail.

25. The method of claim 22, wherein the rail includes a head having top surface with corners or edges, and wherein estimating the shape of the rail within each image comprises:
identifying within the image the corners or edges of the top surface of the rail;
identifying midpoints of the corners or edges and superimposing a transverse line along an anticipated location of the rail length for each corresponding light beam superimposed onto the rail;
comparing an offset of a centerline of the top of the rail relative to a straight reference line connecting the midpoints of each transverse line; and
estimating vertical rail deflection and/or the shape of a deflection basin of the rail based on the comparison of the straight reference line to the centerline.

26. The method of claim 19, further comprising determining a vertical track modulus of the rail based at least in part on the vertical track deflection data.

27. The method of claim 19, further comprising trending a plurality of vertical deflection measurements over a period of time and predicting a future track performance associated with the track.
